(19) United States
(12) Patent Application Publication
(10) Pub. No.: US 2015/0036016 A1
(43) Pub. Date: Feb. 5, 2015

(54) METHODS AND APPARATUS FOR DETERMINING THE ORIENTATION OF A MOBILE PHONE IN AN INDOOR ENVIRONMENT

(71) Applicant: QUALCOMM Incorporated, San Diego, CA (US)

(72) Inventor: Aleksandar Jovicic, Jersey City, NJ (US)

(73) Assignee: QUALCOMM Incorporated, San Diego, CA (US)

(21) Appl. No.: 13/954,356

(22) Filed: Jul. 30, 2013

(51) Int. Cl. G06K 9/62; H04N 5/232

(52) U.S. Cl. CPC G06K 9/62; H04N 5/23229
USPC 348/222.1

(57) ABSTRACT

A method, an apparatus, and a computer program product for wireless communication are provided. The apparatus captures one or more images of at least a first indicator and a second indicator, identifies the first indicator based on first identifying information and identifies the second indicator based on second identifying information, and determines an orientation of the mobile device based on the captured one or more images of the at least the first indicator and the second indicator.

### BACKGROUND

1. Field

The present disclosure relates generally to mobile devices, and more particularly, to methods and apparatus for determining the orientation of a mobile phone in an indoor environment.

2. Background

Determination of the orientation of a mobile device in indoor environments may be useful in a number of applications. For example, the orientation of a mobile device may be needed to navigate mobile phone users in office/commercial environments, to enable customers to find items in a supermarket or retail outlet, for coupon issuance and redemption, and for customer service and accountability. However, achieving precise orientation estimates in indoor venues is a challenging task. Mobile devices typically estimate their orientation using a compass that is built in to the mobile devices. Such orientation estimates, however, are often highly inaccurate due to the presence of metallic objects inside walls, door frames, and furniture in most indoor venues.

### SUMMARY

In an aspect of the disclosure, a method, a computer program product, and an apparatus are provided. The apparatus captures one or more images of at least a first indicator and a second indicator, identifies the first indicator based on first identifying information and identifies the second indicator based on second identifying information, and determines an orientation of the mobile device based on the captured one or more images of the at least the first indicator and the second indicator.

### BRIEF DESCRIPTION OF THE DRAWINGS

FIG. 1 is a diagram illustrating a top view of an indoor venue including a mobile device.

FIG. 2A is a diagram illustrating a mobile device.

FIG. 2B is a diagram illustrating a map of an indoor venue.

FIG. 3 is a flowchart of a method for a mobile device.

FIG. 4 is a flowchart of a method for a mobile device.

FIG. 5 is a conceptual data flow diagram illustrating the data flow between different modules/means/components in an exemplary apparatus.

FIG. 6 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a mobile device will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

As used herein, the term mobile device may refer to a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. Moreover, the term mobile device may also be referred to by those skilled in the art as a mobile station, a subscriber station, a mobile unit, a subscriber unit, a wireless unit, a remote unit, a wireless device, a remote device, a mobile subscriber station, an access terminal, a mobile terminal, a wireless terminal, a remote terminal, a handset, a user agent, a mobile client, a client, or some other suitable terminology.

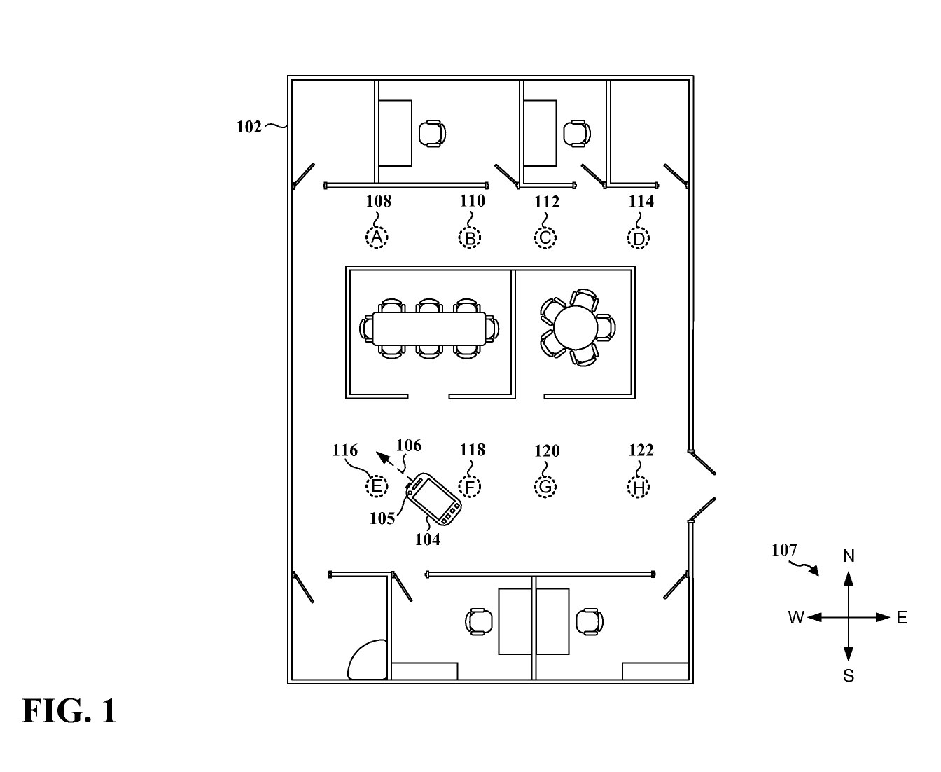

FIG. 1 is a diagram illustrating a top view of an indoor venue including a mobile device 104. In the configuration of FIG. 1, the indoor venue is a floor 102 of an office building. For example, the mobile device 104 may be held by a user who is stationary or moving on the floor 102. In the configuration of FIG. 1, the mobile device 104 is oriented toward a north-west direction with respect to reference axes 107 of the floor 102. For example, as shown in FIG. 1, the orientation axis 106 (e.g., the direction toward which the mobile device 104 is pointed) is oriented toward the north-west direction with respect to the reference axes 107.

In an aspect, floor 102 may include two or more orientation indicators (also referred to as “indicators” or “luminaires”) located above the mobile device 104. In the configuration of FIG. 1, floor 102 includes indicators 108, 110, 112, 114, 116, 118, 120, and 122. It should be understood that floor 102 may include a lesser or greater number of indicators than those indicated in FIG. 1. In an aspect, each of the indicators may be a light fixture or a luminaire and may be configured to communicate information for identifying a corresponding indicator. For example, such light fixture or luminaire may include a light emitting diode (LED) as the light producing element. In another example, each of the indicators may be a visual indicator, such as a QR Code® (also referred to as a quick response code) or a color panel, or may include a unique visual characteristic, such as a distinct shape (e.g., a square shape, a triangular shape, a star shape, etc.). In one configuration, the indicators may each be installed on a ceiling of the floor 102, such that the indicators are visible from the ground of the floor 102. As described infra, the mobile device 104 may be configured to use two or more of the indicators to determine the orientation axis 106 of the mobile device 104 with respect to the reference axes 107.

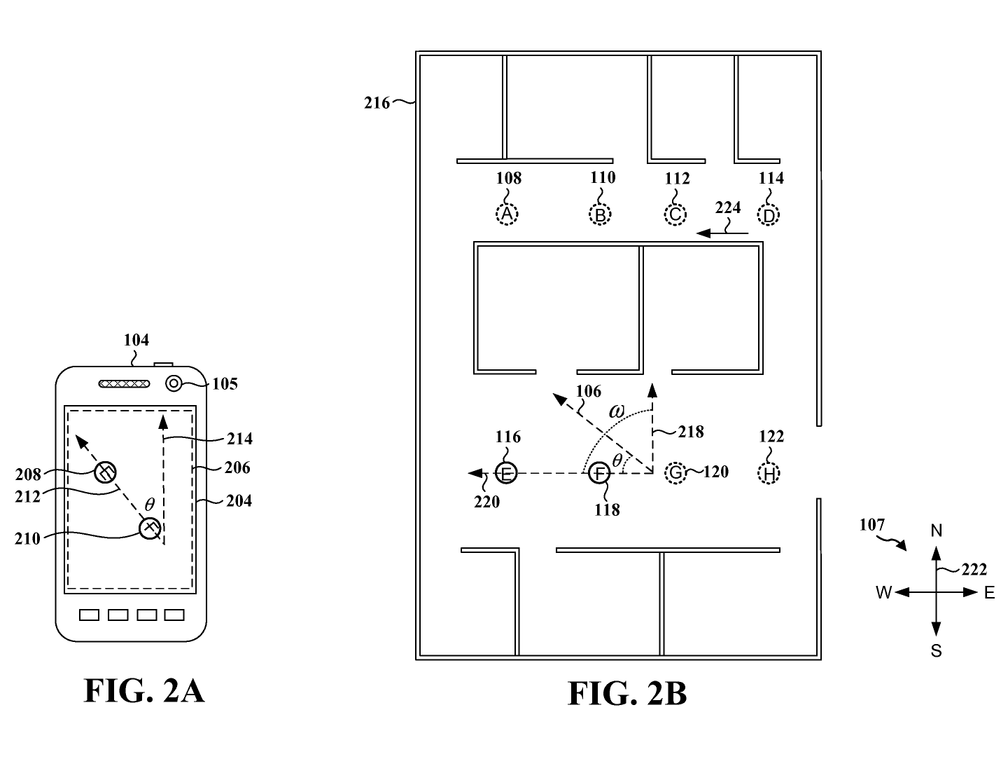

FIG. 2A is a diagram illustrating the mobile device 104. As shown in FIG. 2A, the mobile device 104 includes a front facing camera 105 and a display screen 204. In an aspect, the front facing camera 105 may capture images via a digital image sensor (e.g., a CMOS sensor) installed in the front facing camera 105. The mobile device 104 may display images captured by the front facing camera 105 on the display screen 204.

With reference to FIG. 1, the mobile device 104 may operate the front facing camera 105 to capture one or more images of two or more indicators (e.g., indicators 108, 110, 112, 114, 116, 118, 120, and 122). The mobile device 104 may further operate the front facing camera 105 to receive identifying information from two or more of the indicators (e.g., indicators 108, 110, 112, 114, 116, 118, 120, and 122) located above the mobile device 104 and within a field of view of the front facing camera 105. In one aspect, and as discussed infra, the front facing camera 105 may detect identifying information from one or more of the indicators in FIG. 1 without receiving any identifying information from the one or more indicators.

In an aspect, the indicators (e.g., indicators 108, 110, 112, 114, 116, 118, 120, and 122) may be LED devices configured to transmit visible light communication (VLC) signals. The VLC signals may be detected by the front facing camera 105 and the digital image sensor of the mobile device 104. The VLC signals may then be decoded by the mobile device 104. In such aspect, the VLC signals transmitted by an indicator may contain identification information of the indicator. The mobile device 104 may associate the indicator with the identification information transmitted by the indicator. For example, the identification information transmitted by an indicator may be a 48 bit MAC address that is unique with respect to other indicators. It should be understood that other types of identification information may be transmitted by the indicators if such identification information is unique and allows for disambiguation of an indicator located in a particular venue (e.g., a floor of an office building, supermarket, or shopping mall). In an aspect, the mobile device 104 may be configured to simultaneously decode VLC signals from multiple indicators.

For example, the front facing camera 105 may detect and decode first VLC signals transmitted by indicator E 116 and second VLC signals transmitted by indicator F 118. The mobile device 104 may decode the first VLC signals transmitted by indicator E 116 in order to determine the identifying information included in the first VLC signals and to identify the indicator E 116. The mobile device 104 may decode the second VLC signals transmitted by indicator F 118 in order to determine the identifying information included in the second VLC signals and to identify the indicator F 118. In this example, the mobile device 104 may identify the indicator E 116 based on a first 48 bit MAC address received from the indicator E 116 via the first VLC signals, where the first 48 bit MAC address identifies or corresponds to the indicator E 116. The mobile device 104 may identify the indicator F 118 based on a second 48 bit MAC address received from the indicator F 118 via the second VLC signals, where the second 48 bit MAC address identifies or corresponds to the indicator F 118.

In an aspect, one or more of the indicators (e.g., indicators 108, 110, 112, 114, 116, 118, 120, and 122) may not transmit any information. In such aspect, information may be embedded in the shape, color, and or visual structure of the indicator which may be detected and interpreted by the digital image sensor (e.g., a CMOS sensor) installed in the front facing camera 105.

In an aspect, after the mobile device 104 has identified two or more indicators, the mobile device 104 may reference a map of the venue in which the mobile device 104 is currently located. In one configuration, the map of the venue may include the locations of two or more of the indicators (e.g., indicators 108, 110, 112, 114, 116, 118, 120, and 122) located at the venue.

In an aspect, the map 216 may be stored in a memory of the mobile device 104. In another aspect, the map 216 may be stored on a remote server (not shown). In such aspect, the mobile device 104 may query the remote server for orientation information. For example, the mobile device 104 may send information regarding the identified indicators 116 and 118 to the remote server (also referred to as a network) along with the query. In one configuration, the remote server may respond with the orientation of the mobile device 104. In an aspect, the map 216 may be downloaded to the mobile device 104 using an out-of-band (RF) signal from a wireless local area network (WLAN), a wide area network (WAN), or other network. For example, such downloading of the map 216 may be triggered automatically by the mobile device 104 when mobile device 104 determines that it has entered an indoor venue. For example, the mobile device 104 may determine that it has entered an indoor venue using contextual information or by employing a positioning system that uses a combination of GPS and terrestrial RF technologies.

For example, with reference to FIG. 2B, the mobile device 104 may reference a map 216 of the floor 102. In such example, the mobile device 104 may determine the locations of the identified indicators (e.g., indicator E 116 and indicator F 118) on the map 216 and may determine the orientation of the identified indicators with respect to the reference axes 107. The mobile device 104 may then determine its own orientation axis 106 with respect to the reference axes 107.

An example orientation determination operation of the mobile device 104 will now be described with reference to FIGS. 1, 2A and 2B. As previously described with respect to FIG. 1, the mobile device 104 may capture one or more images of the indicators 116 and 118 via the front facing camera 105, such as the image 206 shown in FIG. 2A. The mobile device 104 identifies the indicators 116 and 118. In an aspect, the mobile device 104 may receive identifying information from each the indicators 116 and 118 via the front facing camera 105 and may identify the indicators 116 and 118 based on the received identifying information. It should be noted that the mobile device 104 captures the image 206 of the indicators 116 and 118 while oriented according to the orientation axis (e.g., orientation axis 106) to be determined by the mobile device 104. The mobile device identifies the locations of indicators 116 and 118 in the captured image 206 on the map 216. The map 216 may be stored in a memory of the mobile device 104 or received from a remote server.

As shown in FIG. 2B, the mobile device 104 may draw a vector 220 on the map 216 connecting the identified indicators 116 and 118. In an aspect, the vector 220 may be drawn to pass through the center of indicator E 116 and the center of indicator F 118 as shown in FIG. 2B. The vector 220 may be referred to as the indicator axis. The mobile device 104 may determine the angle of the indicator axis (e.g., vector 220) relative to a reference axis, such as the north axis 222 of the reference axes 107. For ease of description, the north axis 222 is shown in FIG. 2B as vector 218. The angle ω of the indicator axis (e.g., vector 220) relative to the reference axis (e.g., vector 218) represents the orientation of the indicator axis (e.g., vector 220).

The mobile device 104 may draw a vector 212 on the image 206 captured by the front facing camera 105. In an aspect, the vector 212 may be drawn to pass through the center of the set of pixels identified as indicator E 208 and the center of the set of pixels identified as indicator F 210 as shown in FIG. 2A. The vector 212 may be referred to as the image indicator axis. The mobile device 104 may determine the angle of the image indicator axis (e.g., vector 212) relative to a fixed axis (also referred to as a screen axis) (e.g., vector 214), which is defined as the axis extending from the bottom of the screen 204 to the top of the screen 204. The angle θ of the image indicator axis (e.g., vector 212) relative to the screen axis (e.g., vector 214) represents the orientation of the image indicator axis (e.g., vector 212) relative to the screen axis (e.g., vector 214). The negative of the angle θ represents the orientation axis (e.g., vector 106) of the mobile device 104 relative to the indicator axis (e.g., vector 220). Therefore, the orientation axis (e.g., vector 106) of the mobile device 104 relative to the reference axis (e.g., the north axis 222 represented as vector 218 in FIG. 2B) may be determined by summing the angle ω and the angle −θ. For example, with reference to FIG. 2B, the mobile device 104 may determine the sum of the angle ω and the angle −θ, where the sum represents the angle of the orientation axis (e.g., vector 106) of the mobile device 104 with respect to the reference axis (e.g., vector 218).

In the previously described aspect where the mobile device 104 queries the remote server for orientation information, the mobile device 104 may transmit a query that includes the identities of the indicators 116 and 118 and one or more of the captured images of the indicators 116 and 118 to the remote server. The remote server may then determine the orientation of the mobile device 104 using the identities of the indicators 116 and 118 and the one or more captured images of the indicators 116 and 118. The remote server may then transmit information regarding the orientation of the mobile device 104. The mobile device 104 may receive the information regarding the orientation of the mobile device 104 and may determine its orientation using the received information. For example, the information regarding the orientation of the mobile device 104 received from the remote server may indicate the orientation of the mobile device 104 with respect to a reference axis (e.g., the north axis 222 represented as vector 218 in FIG. 2B). For example, with reference to FIG. 2B, the orientation of the mobile device 104 with respect to the reference axis may be represented as the sum of angle ω and the angle −θ.

It should be understood that the reference axis may be selected to be an axis different from the north axis 222. In an aspect, the reference axis may be any fixed reference axis, such as a magnetic/geographic north axis or south axis, where the reference axis is stored in the map. In another aspect, the reference axis may be determined relative to a reference axis contained in the map. For example, the reference axis may be an axis corresponding to a hallway 224 on the map 216. As another example, the reference axis may be a particular aisle in a supermarket.

It should also be understood that the disclosure herein may be applied to a configuration where the indicators (e.g., indicators 108, 110, 112, 114, 116, 118, 120, and 122) are installed on the ground of the floor 102 (i.e., below the mobile device 104) and where the mobile device 104 uses a rear camera (not shown) to receive information for identifying two or more of the indicators and for capturing one or more images of the indicators.

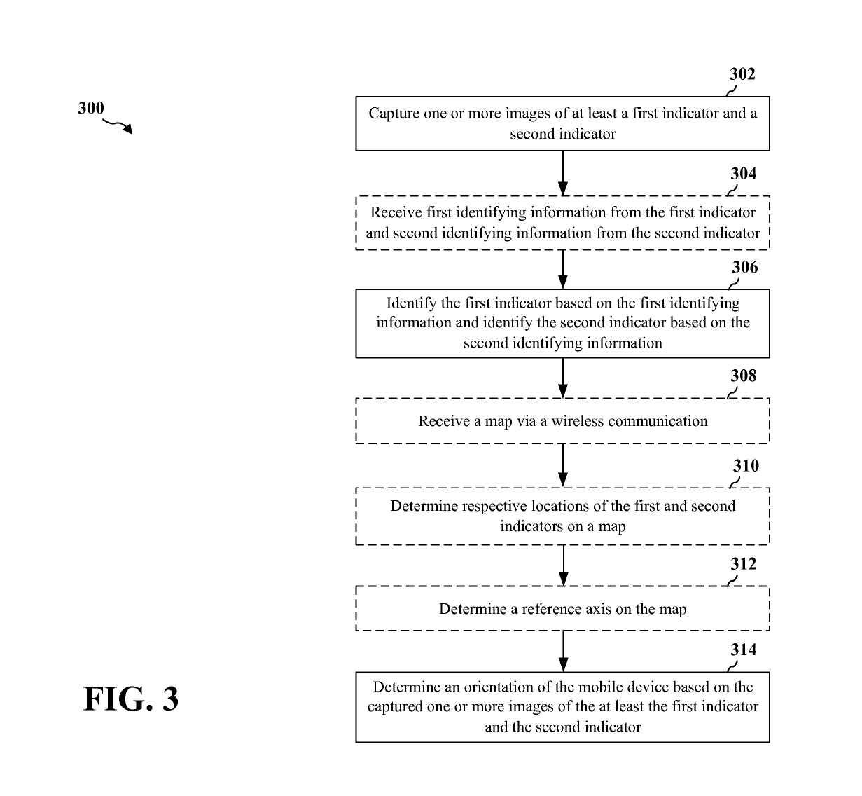

FIG. 3 is a flow chart 300 of a method for a mobile device. For example, the method may be performed by the mobile device 104.

At step 302, the mobile device captures one or more images of at least a first indicator and a second indicator. For example, with reference to FIG. 1, the mobile device 104 may operate the front facing camera 105 to capture one or more images of two or more indicators (e.g., indicator E 116 and indicator F 118).

At step 304, the mobile device receives first identifying information from the first indicator and receives second identifying information from the second indicator. In an aspect, the first and second indicators may be LEDs configured to communicate the identifying information. For example, with reference to FIG. 1, the mobile device 104 may operate the front facing camera 105 to receive identifying information from each of two or more of the indicators (e.g., indicators 108, 110, 112, 114, 116, 118, 120, and 122) located above the mobile device 104 and within a field of view of the front facing camera 105. In an aspect, each indicator may be an LED device configured to transmit a VLC signal that contains identification information of the indicator. For example, the identification information transmitted by an indicator may be a 48 bit MAC address that is unique with respect to other indicators.

At step 306, the mobile device identifies the first indicator based on the first identifying information and identifies the second indicator based on the second identifying information. In one example, with reference to FIG. 1, the mobile device 104 may identify the indicator E 116 based on a first 48 bit MAC address received from the indicator E 116, where the first 48 bit MAC address identifies or corresponds to the indicator E 116. In such example, the mobile device 104 may further identify the indicator F 118 based on a second 48 bit MAC address received from the indicator F 118, where the second 48 bit MAC address identifies or corresponds to the indicator F 118. In another example, with reference to FIG. 1, the mobile device 104 may identify the indicator E 116 based on first identifying information of the indicator E 116 that may be detected by the digital image sensor (e.g., a CMOS sensor) of the front facing camera 105. For example, the first identifying information may be a unique QR Code®, a color panel, or a unique visual characteristic, such as a distinct shape. In such example, the mobile device 104 may identify the indicator F 118 based on second identifying information of the indicator F 118 that may be detected by the digital image sensor (e.g., a CMOS sensor) of the front facing camera 105. For example, the second identifying information may be a unique QR Code®, a color panel, or a unique visual characteristic, such as a distinct shape.

At step 308, the mobile device receives the map via a wireless communication. In an aspect, the map is automatically received when the mobile device is located indoors. For example, with reference to FIG. 2B, the mobile device 104 may receive a map 216 of the indoor venue (e.g., floor 102) shown in FIG. 1. In an aspect, and as shown in FIG. 2B, the map 216 may indicate the locations of the indicators (e.g., indicators 108, 110, 112, 114, 116, 118, 120, and 122) located in the indoor venue.

At step 310, the mobile device determines respective locations of the first and second indicators on a map. For example, with reference to FIG. 2B, the mobile device 104 may determine the locations of indicator E 116 and indicator F 118 on the map 216.

At step 312, the mobile device determines a reference axis on the map. For example, with reference to FIG. 2B, the mobile device 104 may determine the north axis 222 of the reference axes 107 as the reference axis. In an aspect, the reference axis may be indicated in the map 216.

At step 314, the mobile device determines an orientation of the mobile device based on the captured one or more images of the at least the first indicator and the second indicator. In an aspect, the orientation of the mobile device is determined relative to the reference axis. For example, as shown in FIG. 2B, the mobile device 104 may draw the indicator axis (e.g., vector 220) on the map 216 connecting the identified indicators 116 and 118. The mobile device 104 may determine the angle of the indicator axis (e.g., vector 220) relative to a reference axis (e.g., vector 218). The angle ω of the indicator axis (e.g., vector 220) relative to the reference axis (e.g., vector 218) represents the orientation of the indicator axis (e.g., vector 220).

The mobile device 104 may draw the image indicator axis (e.g., vector 212) on the image 206 captured by the front facing camera 105. The mobile device 104 may determine the angle of the image indicator axis (e.g., vector 212) relative to the screen axis (e.g., vector 214), which is defined as the axis extending from the bottom of the screen 212 to the top of the screen 212. The angle θ of the image indicator axis (e.g., vector 212) relative to the screen axis (e.g., vector 214) represents the orientation of the image indicator axis (e.g., vector 212) relative to the screen axis (e.g., vector 214). The negative of the angle θ represents the orientation axis (e.g., vector 106) of the mobile device 104 relative to the indicator axis (e.g., vector 220). Therefore, the orientation axis (e.g., vector 106) of the mobile device 104 relative to the reference axis (e.g., the north axis 222 represented as vector 218 in FIG. 2B) may be determined by summing the angle ω and the angle −θ. For example, with reference to FIG. 2B, the mobile device 104 may determine the sum of the angle ω and the angle −θ, where the sum represents the angle of the orientation axis (e.g., vector 106) of the mobile device 104 with respect to the reference axis (e.g., vector 218).

It should be understood that the steps 304, 308, 310, and 312 indicated with dotted lines in FIG. 3 represent optional steps. For example, in one embodiment, steps 302, 306, and 314 may be performed without performing steps 304, 308, 310, and 312. It should be further understood that various combinations of the steps 304, 308, 310, and 312 may be performed in accordance with various embodiments. For example, in one embodiment, steps 302, 304, 306, and 314 may be performed without performing steps 308, 310, and 312.

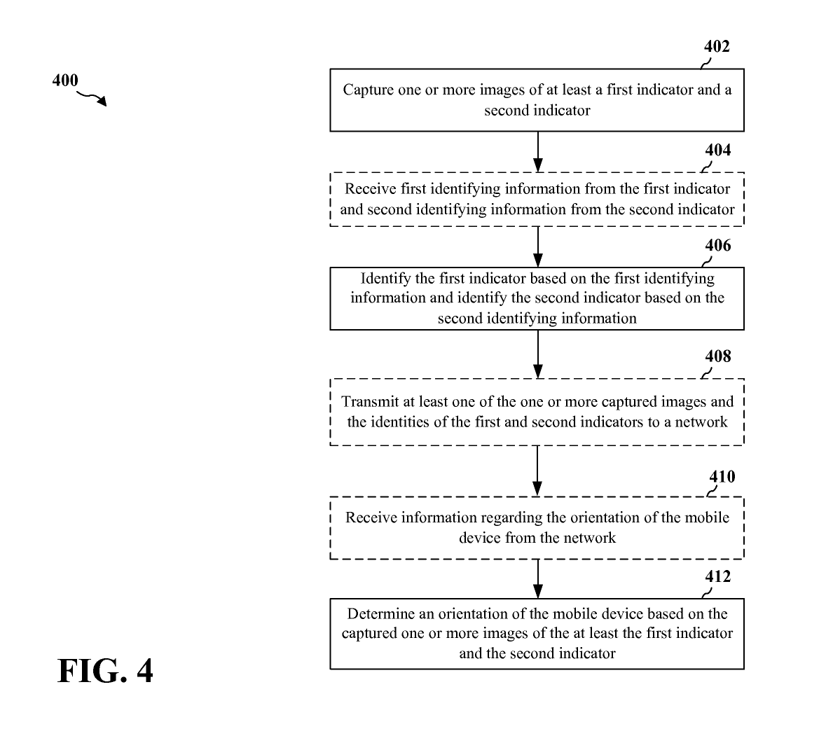

FIG. 4 is a flow chart 400 of a method for a mobile device. For example, the method may be performed by the mobile device 104.

At step 402, the mobile device captures one or more images of at least the first indicator and the second indicator. For example, with reference to FIG. 1, the mobile device 104 may operate the front facing camera 105 to capture one or more images of two or more indicators (e.g., indicator E 116 and indicator F 118).

At step 404, the mobile device receives first identifying information from the first indicator and receives second identifying information from the second indicator. In an aspect, each of the first and second indicators may be an LED configured to communicate the identifying information. For example, with reference to FIG. 1, the mobile device 104 may operate the front facing camera 105 to receive identifying information from two or more of the indicators (e.g., indicators 108, 110, 112, 114, 116, 118, 120, and 122) located above the mobile device 104 and within a field of view of the front facing camera 105. In an aspect, each indicator may be an LED device configured to transmit a VLC signal that contains identification information of the indicator. For example, the identification information transmitted by an indicator may be a 48 bit MAC address that is unique with respect to other indicators.

At step 406, the mobile device identifies the first indicator based on the first identifying information and identifies the second indicator based on the second identifying information. In one example, with reference to FIG. 1, the mobile device 104 may identify the indicator E 116 based on a first 48 bit MAC address received from the indicator E 116, where the first 48 bit MAC address identifies or corresponds to the indicator E 116. In such example, the mobile device 104 may identify the indicator F 118 based on a second 48 bit MAC address received from the indicator F 118, where the second 48 bit MAC address identifies or corresponds to the indicator F 118. In another example, with reference to FIG. 1, the mobile device 104 may identify the indicator E 116 based on first identifying information of the indicator E 116 that may be detected by the digital image sensor (e.g., a CMOS sensor) of the front facing camera 105. For example, the first identifying information may be a unique QR Code®, a color panel, or a unique visual characteristic, such as a distinct shape. In such example, the mobile device 104 may identify the indicator F 118 based on second identifying information of the indicator F 118 that may be detected by the digital image sensor (e.g., a CMOS sensor) of the front facing camera 105. For example, the second identifying information may be a unique QR Code®, a color panel, or a unique visual characteristic, such as a distinct shape.

At step 408, the mobile device transmits at least one of the one or more captured images and the identities of the first and second indicators to a network.

At step 410, the mobile device receives information regarding the orientation of the mobile device from the network.

At step 412, the mobile device determines an orientation of the mobile device based on the captured one or more images of the at least the first indicator and the second indicator. In an aspect, determination of the orientation of the mobile device is further based on the received information regarding the orientation of the mobile device. For example, the information regarding the orientation of the mobile device received from the network may indicate the orientation of the mobile device 104 with respect to a reference axis (e.g., the north axis 222 represented as vector 218 in FIG. 2B). For example, with reference to FIG. 2B, the orientation of the mobile device 104 with respect to a reference axis may be represented as the sum of angle ω and the angle −θ.

It should be understood that the steps 404, 408, and 410 indicated with dotted lines in FIG. 4 represent optional steps. For example, in one embodiment, steps 402, 406, and 412 may be performed without performing steps 404, 408, and 410. It should be further understood that various combinations of the steps 404, 408, and 410 may be performed in accordance with various embodiments. For example, in one embodiment, steps 402, 404, 406, and 412 may be performed without performing steps 408 and 410.

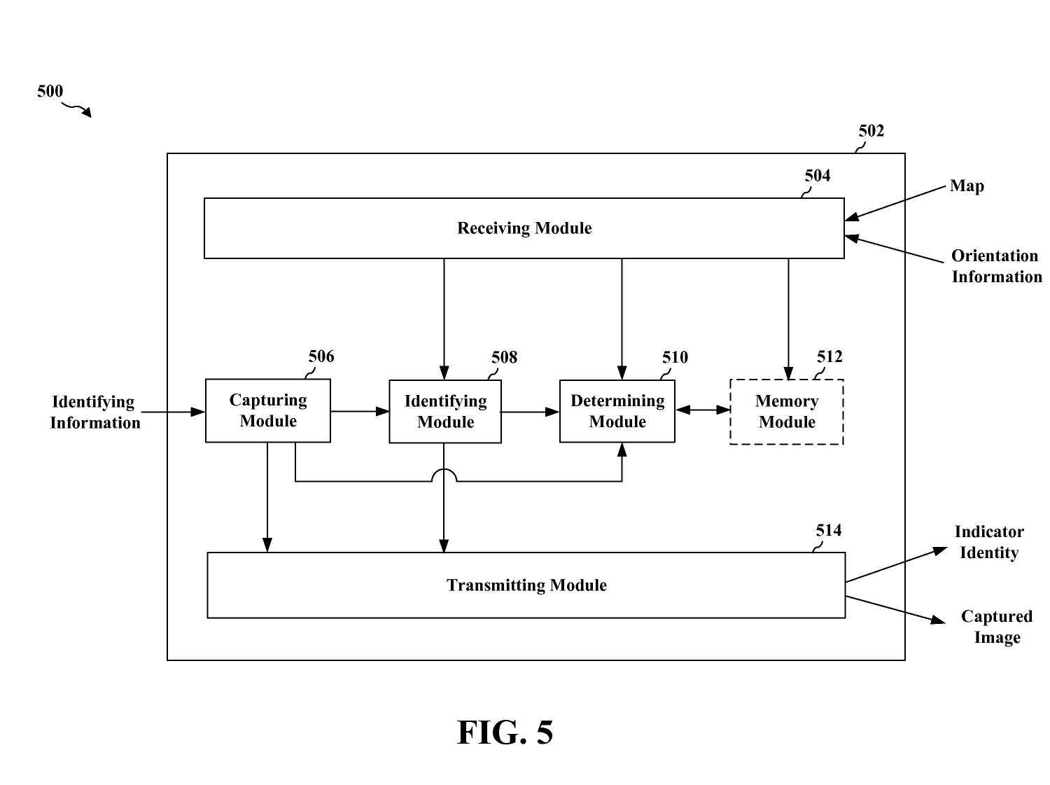

FIG. 5 is a conceptual data flow diagram 500 illustrating the data flow between different modules/means/components in an exemplary apparatus 502. The apparatus may be a mobile device, such as the mobile device 104. The apparatus includes a module 504 that receives information regarding the orientation of the apparatus from the network and that receives a map via a wireless communication, a module 506 that receives first identifying information from a first indicator and second identifying information from a second indicator, and that captures one or more images of at least the first indicator and the second indicator, a module 508 that identifies the first indicator based on the first identifying information and the second indicator based on the second identifying information, a module 510 that determines an orientation of the apparatus based on the captured one or more images of the at least the first indicator and the second indicator, determines respective locations of the first and second indicators on a map, and determines a reference axis on the map, a module 512 that stores a map, and a module 514 that transmits at least one of the one or more captured images and the identities of the first and second indicators to a network.

The apparatus may include additional modules that perform each of the steps of the algorithm in the aforementioned flow charts of FIGS. 3 and 4. As such, each step in the aforementioned flow charts of FIGS. 3 and 4 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

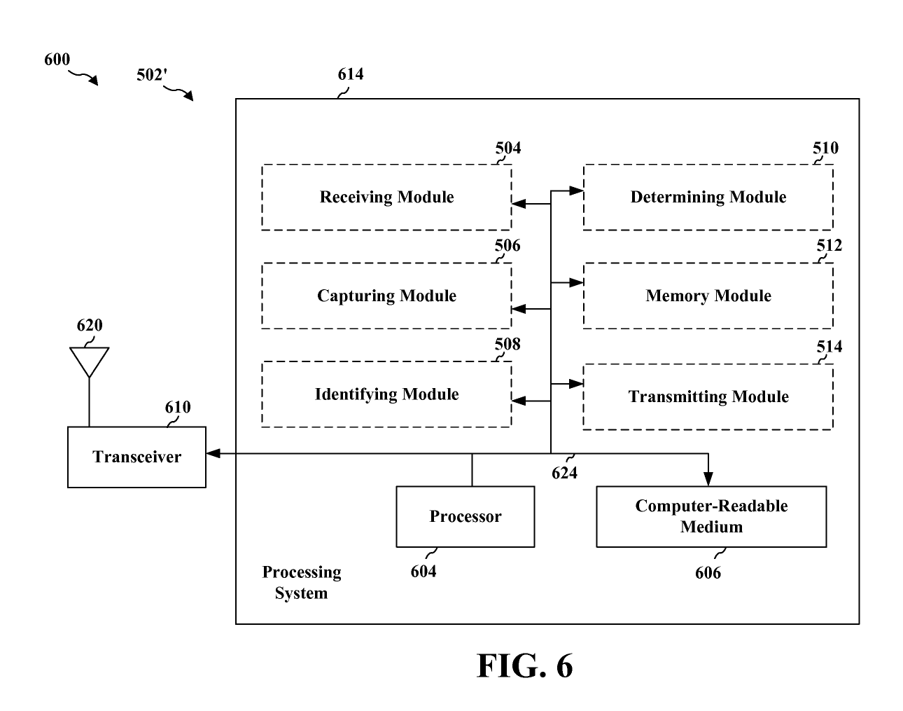

FIG. 6 is a diagram 600 illustrating an example of a hardware implementation for an apparatus 502′ employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 604, the modules 504, 506, 508, 510, 512, and 514, and the computer-readable medium 606. The bus 624 may also link various other circuits such as timing sources, peripherals, voltage regulators, and power management circuits, which are well known in the art, and therefore, will not be described any further.

The processing system 614 may be coupled to a transceiver 610. The transceiver 610 is coupled to one or more antennas 620. The transceiver 610 provides a means for communicating with various other apparatus over a transmission medium. The transceiver 610 receives a signal from the one or more antennas 620, extracts information from the received signal, and provides the extracted information to the processing system 614, specifically the receiving module 504. In addition, the transceiver 610 receives information from the processing system 614, specifically the transmission module 514, and based on the received information, generates a signal to be applied to the one or more antennas 620. The processing system 614 includes a processor 604 coupled to a computer-readable medium 606. The processor 604 is responsible for general processing, including the execution of software stored on the computer-readable medium 606. The software, when executed by the processor 604, causes the processing system 614 to perform the various functions described supra for any particular apparatus. The computer-readable medium 606 may also be used for storing data that is manipulated by the processor 604 when executing software. The processing system further includes at least one of the modules 504, 506, 508, 510, 512, and 514. The modules may be software modules running in the processor 604, resident/stored in the computer readable medium 606, one or more hardware modules coupled to the processor 604, or some combination thereof.

In one configuration, the apparatus 502/502′ for wireless communication includes means for capturing one or more images of at least a first indicator and a second indicator, means for identifying the first indicator based on first identifying information and identifying the second indicator based on second identifying information, means for determining an orientation of the apparatus based on the captured one or more images of the at least a first indicator and a second indicator, means for receiving the first identifying information from the first indicator and the second identifying information from the second indicator, means for determining respective locations of the first and second indicators on a map, means for determining a reference axis on the map, means for transmitting at least one of the one or more captured images and the identities of the first and second indicators to a network, means for receiving information regarding the orientation of the apparatus from the network, and means for receiving the map via a wireless communication. The aforementioned means may be one or more of the aforementioned modules of the apparatus 502 and/or the processing system 614 of the apparatus 502′ configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for a mobile device comprising:
capturing one or more images of at least a first indicator and a second indicator;
identifying the first indicator based on first identifying information and identifying the second indicator based on second identifying information; and
determining an orientation of the mobile device based on the captured one or more images of the at least the first indicator and the second indicator.

2. The method of claim 1, further comprising receiving the first identifying information from the first indicator and the second identifying information from the second indicator.

3. The method of claim 1, further comprising:
determining respective locations of the first and second indicators on a map; and
determining a reference axis on the map,
wherein the orientation of the mobile device is determined relative to the reference axis.

4. The method of claim 3, wherein the first and second indicators are situated along a first axis on the map, the first axis forming a first angle relative to the reference axis, wherein determining the orientation of the mobile device comprises:
determining a second axis on which the first and second indicators are situated in one of the captured one or more images; and
determining a second angle formed by the second axis relative to a fixed axis of the mobile device,
wherein determining the orientation of the mobile device is further based on the first and second angles.

5. The method of claim 1, further comprising:
transmitting at least one of the one or more captured images and the identities of the first and second indicators to a network; and
receiving information regarding the orientation of the mobile device from the network,
wherein determining the orientation of the mobile device is further based on the received information regarding the orientation of the mobile device.

6. The method of claim 1, wherein each of the first and second indicators comprises a light emitting diode (LED) configured to communicate the identifying information.

7. The method of claim 1, wherein the first and second identifying information each comprise a QR code or a unique visual characteristic

8. The method of claim 7, wherein the unique visual characteristic comprises a color or a shape.

9. The method of claim 3, further comprising receiving the map via a wireless communication.

10. The method of claim 9, wherein the map is automatically received when the mobile device is located indoors.

11. An apparatus for wireless communication, comprising:
means for capturing one or more images of at least a first indicator and a second indicator; and
means for identifying the first indicator based on first identifying information and identifying the second indicator based on second identifying information; and
means for determining an orientation of the apparatus based on the captured one or more images of the at least a first indicator and a second indicator.

12. The apparatus of claim 11, further comprising means for receiving the first identifying information from the first indicator and the second identifying information from the second indicator.

13. The apparatus of claim 11, further comprising:
means for determining respective locations of the first and second indicators on a map; and
means for determining a reference axis on the map,
wherein the orientation of the apparatus is determined relative to the reference axis.

14. The apparatus of claim 13, wherein the first and second indicators are situated along a first axis on the map, the first axis forming a first angle relative to the reference axis, wherein determining the orientation of the apparatus comprises:
determining a second axis on which the first and second indicators are situated in one of the captured one or more images; and
determining a second angle formed by the second axis relative to a fixed axis of the apparatus,
wherein determining the orientation of the apparatus is further based on the first and second angles.

15. The apparatus of claim 11, further comprising:
means for transmitting at least one of the one or more captured images and the identities of the first and second indicators to a network; and
means for receiving information regarding the orientation of the apparatus from the network,
wherein determining the orientation of the apparatus is further based on the received information regarding the orientation of the apparatus.

16. The apparatus of claim 11, wherein each of the first and second indicators comprises a light emitting diode (LED) configured to communicate the identifying information.

17. The apparatus of claim 11, wherein the first and second identifying information each comprise a QR code or a unique visual characteristic.

18. The apparatus of claim 17, wherein the unique visual characteristic comprises a color or a shape.

19. The apparatus of claim 13, further comprising means for receiving the map via a wireless communication.

20. The apparatus of claim 19, wherein the map is automatically received when the apparatus is located indoors.

21. An apparatus for wireless communication, comprising:
a processing system configured to:
capture one or more images of at least a first indicator and a second indicator;
identify the first indicator based on first identifying information and identify the second indicator based on second identifying information; and
determine an orientation of the apparatus based on the captured one or more images of the at least the first indicator and the second indicator.

22. The apparatus of claim 21, the processing system further configured to receive the first identifying information from the first indicator and the second identifying information from the second indicator.

23. The apparatus of claim 21, the processing system further configured to:
determine respective locations of the first and second indicators on a map; and
determine a reference axis on the map,
wherein the orientation of the apparatus is determined relative to the reference axis.

24. The apparatus of claim 23, wherein the first and second indicators are situated along a first axis on the map, the first axis forming a first angle relative to the reference axis, wherein determining the orientation of the apparatus comprises:
determining a second axis on which the first and second indicators are situated in one of the captured one or more images; and
determining a second angle formed by the second axis relative to a fixed axis of the apparatus,
wherein determining the orientation of the apparatus is further based on the first and second angles.

25. The apparatus of claim 21, the processing system further configured to:
transmit at least one of the one or more captured images and the identities of the first and second indicators to a network; and
receive information regarding the orientation of the apparatus from the network,
wherein determining the orientation of the apparatus is further based on the received information regarding the orientation of the apparatus.

26. The apparatus of claim 21, wherein each of the first and second indicators comprises a light emitting diode (LED) configured to communicate the identifying information.

27. The apparatus of claim 21, wherein the first and second identifying information each comprise a QR code or a unique visual characteristic.

28. The apparatus of claim 27, wherein the unique visual characteristic comprises a color or a shape.

29. The apparatus of claim 23, the processing system further configured to receive the map via a wireless communication.

30. The apparatus of claim 29, wherein the map is automatically received when the apparatus is located indoors.

31. A computer program product, comprising:
a computer-readable medium comprising code for:
capturing one or more images of at least a first indicator and a second indicator;
identifying the first indicator based on first identifying information and identifying the second indicator based on second identifying information; and
determining an orientation of a mobile device based on the captured one or more images of the at least the first indicator and the second indicator.

32. The computer program product of claim 31, the computer-readable medium further comprising code for receiving the first identifying information from the first indicator and the second identifying information from the second indicator.

33. The computer program product of claim 31, the computer-readable medium further comprising code for:
determining respective locations of the first and second indicators on a map; and
determining a reference axis on the map,
wherein the orientation of the mobile device is determined relative to the reference axis.

34. The computer program product of claim 33, wherein the first and second indicators are situated along a first axis on the map, the first axis forming a first angle relative to the reference axis, wherein determining the orientation of the mobile device comprises:
determining a second axis on which the first and second indicators are situated in one of the captured one or more images; and
determining a second angle formed by the second axis relative to a fixed axis of the mobile device,
wherein determining the orientation of the mobile device is further based on the first and second angles.

35. The computer program product of claim 31, the computer-readable medium further comprising code for:
transmitting at least one of the one or more captured images and the identities of the first and second indicators to a network; and
receiving information regarding the orientation of the mobile device from the network,
wherein determining the orientation of the mobile device is further based on the received information regarding the orientation of the mobile device.

36. The computer program product of claim 31, wherein each of the first and second indicators comprises a light emitting diode (LED) configured to communicate the identifying information.

37. The computer program product of claim 31, wherein the first and second identifying information each comprise a QR code or a unique visual characteristic.

38. The computer program product of claim 37, wherein the unique visual characteristic comprises a color or a shape.

39. The computer program product of claim 33, the computer-readable medium further comprising code for receiving the map via a wireless communication.

40. The computer program product of claim 39, wherein the map is automatically received when the mobile device is located indoors.
